(19) United States
(12) Patent Application Publication
(10) Pub. No.: US 2014/0286249 A1
(43) Pub. Date: Sep. 25, 2014

(54) WIRELESS COMMUNICATION DEVICE AND WIRELESS COMMUNICATION CHANNEL SELECTING METHOD

(71) Applicant: BUFFALO INC., Nagoya-shi (JP)

(72) Inventors: Daisuke YAMADA, Nagoya-shi (JP); Nagahiro MATSUURA, Nagoya-shi (JP); Tomoaki OHARA, Nagoya-shi (JP); Goki ICHIKAWA, Nagoya-shi (JP)

(73) Assignee: BUFFALO INC., Nagoya-shi (JP)

(21) Appl. No.: 14/209,153

(22) Filed: Mar. 13, 2014

(30) Foreign Application Priority Data
Mar. 19, 2013 (JP) 2013-55923

(51) Int. Cl. H04W 72/08; H04W 72/04

(52) U.S. Cl. CPC H04W 72/082; H04W 72/0453
USPC 370/329

(57) ABSTRACT

A wireless communication device that obtains a current degree of interference at each of a plurality of available channels; determines whether a wireless communication is susceptible to interference based on whether a condition corresponding to implementation of the wireless communication is satisfied; and sets a channel for the wireless communication among the plurality of available channels based on the current degree of interference at each of the plurality of available channels when it is determined that the wireless communication is susceptible to interference

### CROSS-REFERENCE TO RELATED APPLICATIONS

The present application claims priority from Japanese Patent Application No. 2013-55923 filed on Mar. 19, 2013, the entirety of disclosure of which is hereby incorporated by reference into this application.

### FIELD OF THE DISCLOSURE

The disclosure relates to wires communication.

### DESCRIPTION OF THE RELATED ART

A wireless communication device (for example, access point) used for wireless communication may be capable of collecting only fragmental information in time series with respect to channels other than a communication channel used for communication and may be incapable of checking the continuous status of use. By taking into account such state, a known technique adds the vacancy status of adjacent channels when a channel is to be selected based on the carrier sense.

### SUMMARY

The above technique, however, enables the wireless communication device to monitor only the channel used for communication and the adjacent channels to this channel, so that it is difficult to find and use a channel for wireless communication that is less susceptible to interference of radio wave, even if such a channel is present. Introduction of a management device such as a wireless switch to manage available channels in a wide range of frequency band and thereby find such a channel for wireless communication causes a complicated network configuration and a cost increase.

By taking into account the foregoing, the problem to be solved by the disclosure is to enable selection of a channel according to the susceptibility to interference of radio wave, while avoiding significant complication of the network configuration and a significant increase in cost. Other needs include, for example, downsizing of a device, resource saving, easiness of manufacture and improved usability.

In order to solve at least part of the problems described above, the disclosure may be implemented by the following aspect.

According to one aspect of the disclosure, there is provided a wireless communication device that obtains a current degree of interference at each of a plurality of available channels; determines whether a wireless communication is susceptible to interference based on whether a condition corresponding to implementation of the wireless communication is satisfied; and sets a channel for the wireless communication among the plurality of available channels based on the current degree of interference at each of the plurality of available channels when it is determined that the wireless communication is susceptible to interference.

### BRIEF DESCRIPTION OF THE DRAWINGS

FIG. 1 is a diagram illustrating the schematic configuration of a network system;

FIG. 2 is a block diagram schematically illustrating the internal configuration of a wireless communication device;

FIG. 3 is a flowchart showing a history acquisition process;

FIG. 4 is a bar graph illustrating history information;

FIG. 5 is a flowchart showing a channel selection process;

FIG. 6 is a flowchart showing a switchover necessity judgment process;

FIG. 7 is a flowchart showing a channel determination process;

FIG. 8 is a block diagram illustrating a wireless communication device according to a second embodiment; and

FIG. 9 is a flowchart showing a channel selection process performed by the wireless communication device according to the second embodiment.

### DESCRIPTION OF EMBODIMENTS

### A. First Embodiment

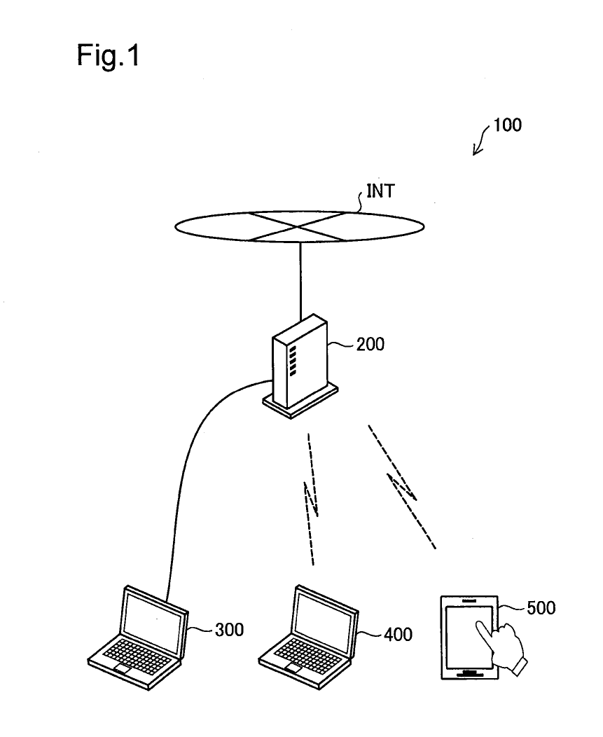

FIG. 1 schematically illustrates a network system 1000 according to an embodiment. The illustrated network system 100 includes a wireless communication device 200 and three client devices 300, 400 and 500.

The wireless communication device 200 is a wireless LAN access point in conformity with the IEEE 802.11 standard and is connected to the Internet INT via a cable. The wireless communication device 200 also serves as a third layer router in the OSI reference model to relay wireless communication and wired communication with the client devices 300, 400 and 500.

The client device 300 is a personal computer equipped with a wired communication interface in conformity with the IEEE 802.3 standard. The client device 400 is a personal computer equipped with a wireless communication interface in conformity with the IEEE 802.11 standard. The client device 500 is a mobile terminal equipped with a wireless communication interface in conformity with the IEEE 802.11 standard. In the illustrated example of FIG. 1, the client device 300 is connected with the wireless communication device 200 with wires, and the client devices 400 and 500 are connected with the wireless communication device 200 wirelessly.

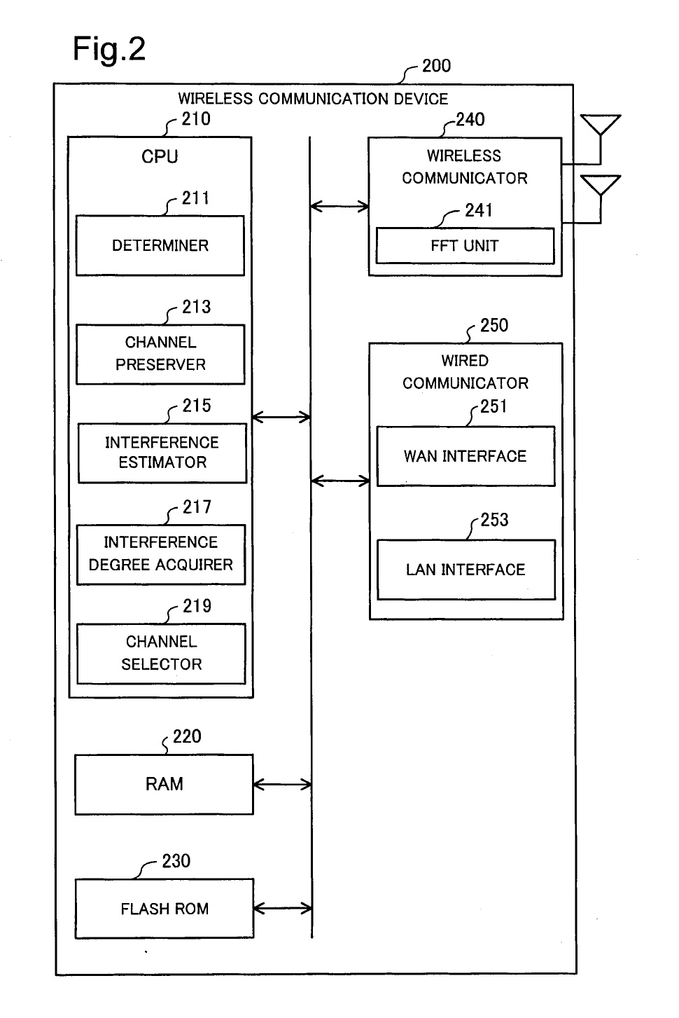

FIG. 2 is a block diagram schematically illustrating the internal configuration of the wireless communication device 200. The wireless communication device 200 includes a CPU 210, a RAM 220, a flash ROM 230, a wireless communicator 240 and a wired communicator 250. The respective components are interconnected by a bus.

The CPU 210 executes programs described later to serve as a determiner 211, a channel retainer 213, an interference estimator 215, an interference degree acquirer 217 and a channel selector 219. The flash ROM 230 stores various programs for processes like a history acquisition process and a channel selection process described later. The RAM 220 is used when the CPU 210 executes programs.

The wireless communicator 240 performs demodulation of radio waves received via the antenna and generation of data, as well as generation and modulation of radio waves to be sent via the antenna. The wireless communicator 240 is capable of making communication using channels in a 2.4 GHz band and communication using channels in a 5 GHz band. The wireless communicator 240 employs MIMO (Multiple Input Multiple Output) and enables radio waves to be sent and received by using two antennas.

The wireless communicator 240 includes an FFT unit 241. The FFT unit 241 analyzes signals received from the two antennas by FFT (fast Fourier transform). This analysis is performed for calculation of RSSI (received signal strength indicator) with respect to each subcarrier. RSSI herein means the received signal strength that excludes radio waves transmitted from the own terminal but includes radio waves transmitted from other communication terminals and noises. According to this embodiment, RSSI with respect to each subcarrier is used as an index indicating the degree of interference of each channel at the time. The subcarriers as the target of analysis are all the subcarriers included in all the channels available for communication. For example, in the case of the 5 GHz band, RSSI of every 312.5 kHz is calculated for a W52 band (5.17 to 5.25 GHz), a W53 band (5.25 to 5.33 GHz) and a W56 band (5.49 to 5.71 GHz).

The CPU 210 continually, i.e., repeatedly performs ISM (In Service Monitoring) for a use channel. The CPU 210, on the other hand, continually, i.e., repeatedly monitors detection or non-detection of radar waves with respect to each of non-use channels. According to this embodiment, the result of radar wave detection is also used as an index indicating the degree of interference of each channel. The channels as the target of monitoring of the radar wave detection are all the channels including channels belonging to the W53 band and channels belonging to the W56 band. Detection of radar wave is based on the results of analysis of the received signals obtained from the FFT unit 241. Such monitoring of radar wave may be interpreted as CAC (Channel Availability Check) for non-use channels. Monitoring of radar wave is also interpreted as CAC for all the channels on the power supply and continual ISM for all the channels. In either of these interpretations, monitoring of radar wave is performed for all the relevant channels. It is accordingly not required to perform CAC accompanied with a channel switchover.

The radars as the target of detection include both stationary radars and moving radars. The radar waves as the target of detection are those having a specific waveform pattern. The stationary radars include, for example, weathering radars and airport radars. The moving radars include, for example, military radars and ship radars. The CPU 210 performs a channel selection process described later to implement DFS (Dynamic Frequency Selection) to meet the legal requirements.

The wired communicator 250 performs a process of shaping the waveform of a received signal and a process of extracting a MAC frame from the received signal. The wired communicator 250 includes a WAN interface 251 and a LAN interface 253. The WAN interface 251 is connected with a line on the Internet INT side. The LAN interface 253 is connected with the client device 300.

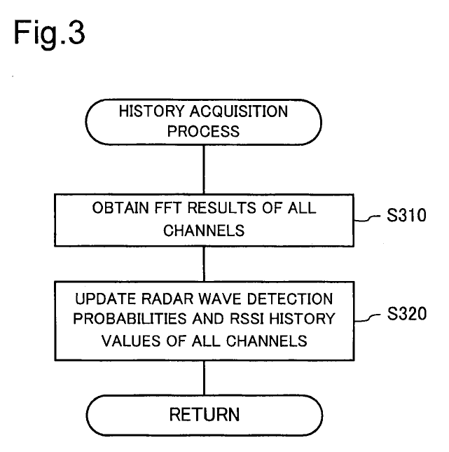

FIG. 3 is a flowchart showing a history acquisition process. The history acquisition process is continually performed by the CPU 210. On the start of the history acquisition process, the interference degree acquirer 217 of the CPU 210 obtains the RSSIs of all the subcarriers from the FFT unit 241 (step S310). The CPU 210 subsequently records history values of RSSIs and frequencies of radar wave detection for the respective channels (hereinafter these two pieces of information are collectively called “history information”), based on the current time and the obtained RSSIs (step S320) and returns the process flow to step S310. The channels belonging to a band other than the W53 band and the W56 band are not the target of radar wave detection and are thus out of the target of counting the frequency of radar wave detection. In a second or subsequent cycle of step S320, the “history information” is updated, based on the current time and RSSIs.

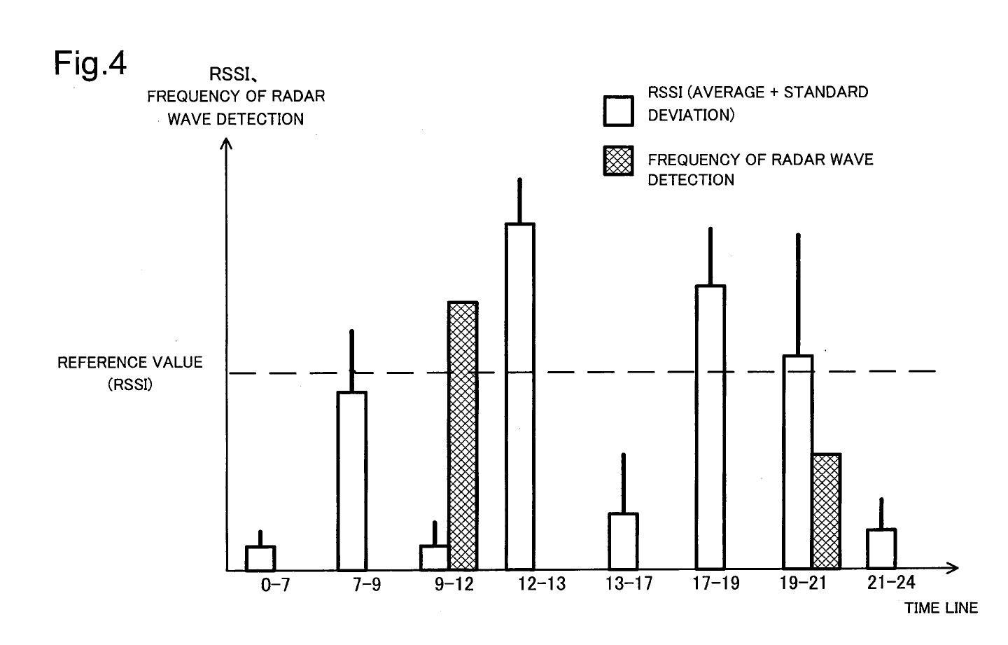

FIG. 4 is a bar graph illustrating history information. The history information shown in FIG. 4 is organized for one channel as the target with respect to a day of the week. The abscissa of the graph shows the timeline. The history information is calculated, based on data obtained in a predetermined time period (for example, in latest 10 weeks).

According to this embodiment, based on the prediction that the history information has some regularity relating to the day of the week and the time, the history information is grouped and organized by the day of the week and the time. According to this embodiment, the timeline is not divided at equal intervals. Division of the timeline is determined according to the desired details of data acquisition in each time division.

The history value of RSSI is an average of RSSIs obtained in the predetermined time period. The history value of RSSI is recorded in association with a standard deviation. The standard deviation is shown by an error bar in FIG. 4. The frequency of radar wave detection shows the number of times of radar wave detection in each time division during the predetermined time period. For example, when the predetermined time period is 10 weeks, the time division of 12 o'clock to 13 o'clock on Monday appears ten times in the predetermined time period. The number of times of radar wave detection in this time division is specified as the frequency of radar wave detection in the time division of 12 o'clock to 13 o'clock on Monday.

Reference values are predetermined for the history value of RSSI and the frequency of radar wave detection. The reference value of the history value of RSSI and the reference value of the frequency of radar wave detection are used in a channel selection process described later. The reference value of the history value of RSSI is shown in FIG. 4. The reference value of the frequency of radar wave detection is zero in this embodiment and is accordingly not shown in FIG. 4.

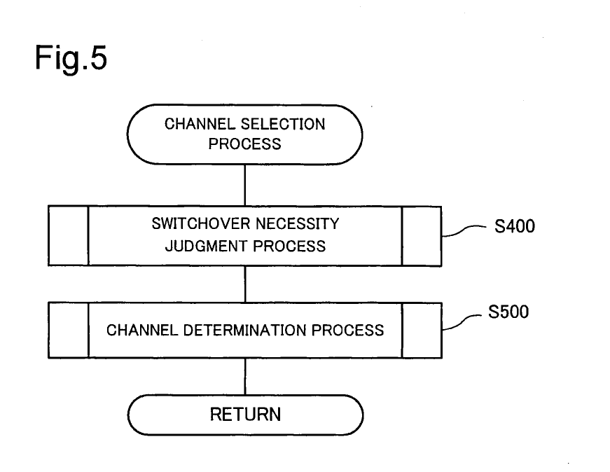

FIG. 5 is a flowchart showing a channel selection process. The channel selection process is performed by the CPU 210 during wireless communication. On the start of the channel selection process, the CPU 210 repeatedly performs a switchover necessity judgment process (step S400) and a channel determination process (step S500). The channel determination process (step S500) is performed when it is determined that a specified condition for switching over the channel used for wireless communication is fulfilled in the switchover necessity judgment process (step S400).

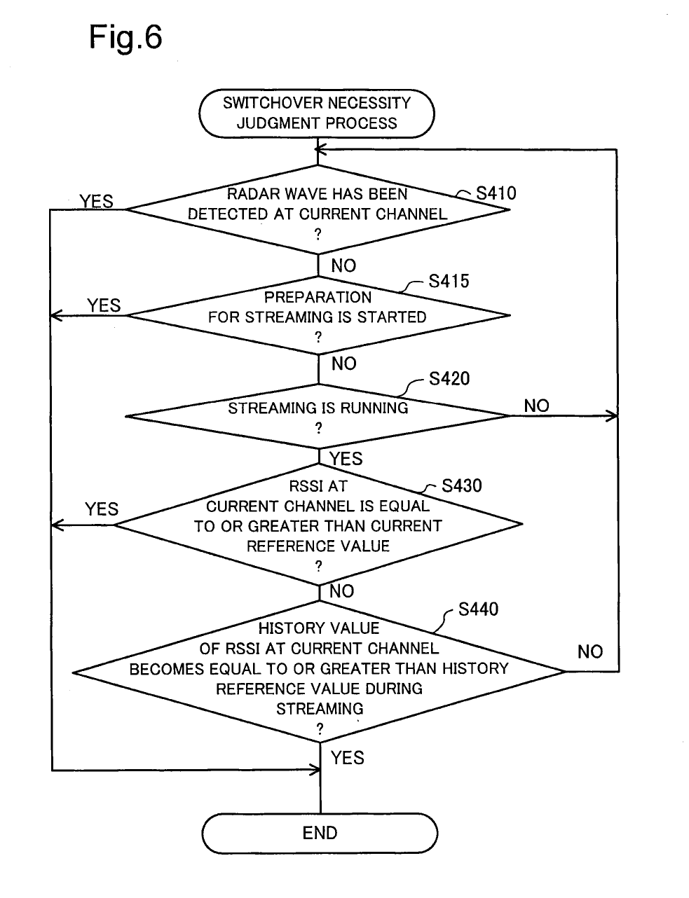

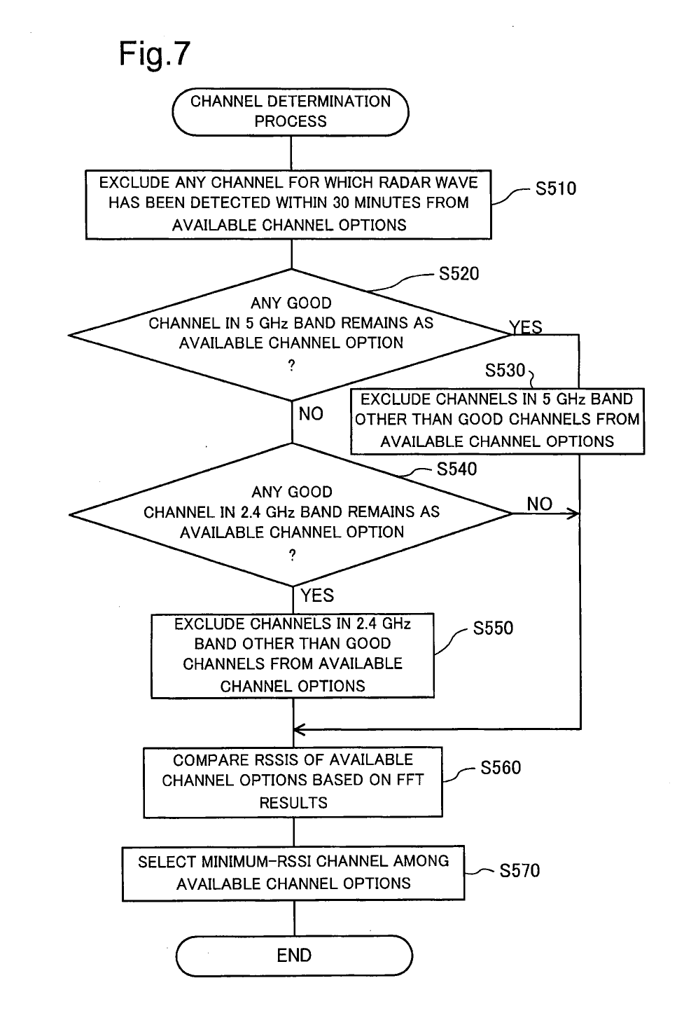

FIG. 6 is a flowchart showing the switchover necessity judgment process (step S400 in FIG. 5). The CPU 210 first determines whether radar wave has been detected at a channel currently used for wireless communication (hereinafter referred to as “current channel”) (step S410). When radar wave has been detected at the current channel (step S410: YES), the switchover necessity judgment process is terminated. On termination of the switchover necessity judgment process, the CPU 210 performs the channel determination process (step S500) as described above. This processing flow can avoid interference with the detected radar wave. The channel determination process will be described later with reference to FIG. 7.

When no radar wave has been detected (step S410: NO), it is determined whether preparation for streaming has been started (step S415). More specifically, the CPU 210 determines that “preparation for streaming has been started” at step S415 in a first cycle after an access to a specified port number, while otherwise determining that “preparation for streaming has not been started”. When preparation for streaming has been started (step S415: YES), the switchover necessity judgment process is terminated. This processing flow can determine a channel at which streaming is unlikely to be interrupted after a start of streaming in the channel determination process (step S500) and start streaming. The decision of YES at step S415 may be interpreted as that the CPU 210 determines that wireless communication, for which preparation has been started, is susceptible to interference of radio waves. When preparation for streaming has not been started (step S415: NO), the determiner 211 of the CPU 210 determines whether streaming is running (step S420). When the streaming is not running (step S420: NO), the processing flow returns to step S410.

When streaming is running (step S420: YES), the channel retainer 213 of the CPU 210 determines whether the current RSSI at the current channel is equal to or greater than a reference value (step S430). The reference value used at step S430 is not necessarily the same value as the reference value determined with respect to the history information. In the description below, the reference value used at step S430 is referred to as “current reference value”, and the reference value determined with respect to the history information is referred to as “history reference value”. With respect to step S430, when the current RSSI at the current channel is equal to or greater than the current reference value (step S430: YES), the switchover necessity judgment process is terminated. This processing flow makes it possible to determine a channel having the lower RSSI than that of the current channel in the channel determination process (step S500) and perform streaming.

When the current RSSI at the current channel is less than the current reference value (step S430: NO), the CPU 210 determines whether the history value of RSSI at the current channel becomes equal to or greater than the history reference value during streaming (step S440). This determination is based on whether a history value of RSSI of interest is equal to or greater than the history reference value. The history value of RSSI of interest is a history value of RSSI corresponding to the day of the week and the time which a time period from the current time to an expected end time of active streaming (hereinafter referred to as “streaming period”) belongs to. The streaming period may cross over a plurality of time divisions shown in FIG. 4. In this case, when the history value of RSSI is equal to or greater than the history reference value in at least one time division, the decision at step S440 is YES.

When the history value of RSSI at the current channel does not become equal to or greater than the history reference value during streaming (step S440: NO), the processing flow returns to step S410. When the history value of RSSI at the current channel becomes equal to or greater than the history reference value during streaming (step S440: YES), the switchover necessity judgment process is terminated. This processing flow makes it possible to determine a channel having a lower probability of increasing RSSI during streaming period than the current channel in the channel determination process (step S500) and perform streaming.

FIG. 7 is a flowchart showing the channel determination process (step S500 in FIG. 5). The interference degree acquirer 217 of the CPU 210 first excludes any channel for which radar wave has been detected last within 30 minutes among the channels belonging to either of the W53 and W56 bands, from available channel options (step S510). The available channel options are candidate channels to be switched over to and correspond to all channels including the current channel as the default setting.

The CPU 210 subsequently determines whether there is any available channel option meeting both the following conditions 1 and 2 (hereinafter referred to as “good channel”) among the channels in the 5 GHz band (step S520). The condition 1 is that the frequency of radar wave detection is equal to or less than a reference value (e.g., 0 in this embodiment) in a time division that is included in the predetermined time period (e.g., latest 10 weeks in this embodiment) and corresponds to the day of the week and the time which the streaming period belongs to. The condition 2 is that the history value of RSSI is less than the history reference value. The “available channel option having the history value of RSSI that is less than the history reference value” at this decision includes “available channel option having the history value of RSSI that is equal to or greater than the history reference value and having a large standard deviation”, in addition to the literal “available channel option having the history value of RSSI that is less than the history reference value”. According to this embodiment, in the case of a large standard deviation, a large history value of RSSI is regarded as unreliable, as the information to exclude a channel from available channel options. As a result, the “good channels” may include available channel options having the frequency of radar wave detection that is equal to or less than the reference value, having the history value of RSSI that is equal to or greater than the history reference value, and having a large standard deviation during the streaming period. The case of the large standard deviation is, for example, the time division of 19 o'clock to 21 o'clock shown in FIG. 4 and the case where the value of standard deviation is equal to or greater than a specified ratio (for example, 30%) of the average value.

When there is any good channel among the channels in the 5 GHz band, i.e., when any good channel in the 5 GHz band remains as an available channel option (step S520: YES), the interference estimator 215 of the CPU 210 excludes channels in the 5 GHz band other than the good channels from the available channel options (step S530). This results in excluding any channel expected to have interference based on the obtained history from the available channel options. This also results in excluding any channel for which radar wave has been detected in a time division corresponding to the day of the week and the time which the streaming period belongs to in the latest 10 weeks. As the result of step S530, good channels in the 5 GHz band are set as available channel options.

When there is no good channel among the channels in the 5 GHz band, i.e., when no good channel in the 5 GHz band remains as an available channel option (step S520: NO), the processing flow proceeds to step S540. The CPU 210 determines whether there is any good channel among the channels in the 2.4 GHz band, i.e., whether any good channel in the 2.4 GHz band remains as an available channel option (step S540). When any good channel in the 2.4 GHz band remains as an available channel option (step S540: YES), the interference estimator 215 of the CPU 210 excludes channels in the 2.4 GHz band other than the good channels from the available channel options (step S550). This results in excluding any channel expected to have interference based on the obtained history from the available channel options. This also results in excluding any channel for which radar wave has been detected in a time division corresponding to the day of the week and the time which the streaming period belongs to in the latest 10 weeks. As the result of step S550, good channels in the 2.4 GHz band are set as available channel options.

When there is no good channel among the channels in the 2.4 GHz band, i.e., when no good channel in the 2.4 GHz band remains as an available channel option (step S540: NO), the CPU 210 performs subsequent step S560 described below without excluding channels other than good channels from the available channel options.

After the decision of NO at step S540 or after steps % 30 or step S550, the interference degree acquirer 217 of the CPU 210 obtains the current RSSI of each of the available channel options (step S560). Subsequently the channel selector 219 of the CPU 210 determines a channel having the minimum RSSI among the available channel options as a channel to be switched over to (step S570). The channel selector 219 also starts wireless communication at the newly switched channel (step S570). The CPU 210 then terminates the channel determination process.

When a channel belonging to either the W53 band or the W56 band is selected at step S570, the CPU 210 starts wireless communication at the selected channel without performing one-minute CAC anew. Monitoring of radar wave is continually performed as described above, so that it is thought that selection of a channel at step S570 substantially meets the legal requirements without performing one-minute CAC anew.

This embodiment has at least the following advantageous effects: (a) When streaming is not performed (for example, when the user browses a website), the channel determination process is not performed (S420 in FIG. 6). This prevents a channel switchover beyond necessity; (b) The necessity of a channel switchover is judged, based on the history information as well as the current RSSI and the result of radar wave detection (S440 in FIG. 6). This reduces the possibility that wireless communication is interrupted during streaming; (c) The channel to be switched over to is not selected at random but is selected based on the history of RSSI and radar (S520 and S540 in FIG. 7). This reduces the possibility that the newly switched channel is again required to be switched over in a short time period; (d) The history is obtained continually for all the channels by using FFT (241 in FIG. 2). This enhances the accuracy of interference estimation using the history information; (e) Continually performing CAC prevents one-minute interruption of communication associated with ordinary CAC (S510 and S570 in FIGS. 7); and (f) The above advantageous effects are obtained by the configuration of the wireless communication device 200 and do not require any additional management or equivalent device. Accordingly, this does not significantly complicate the network configuration or does not significantly increase the cost.

### B. Second Embodiment

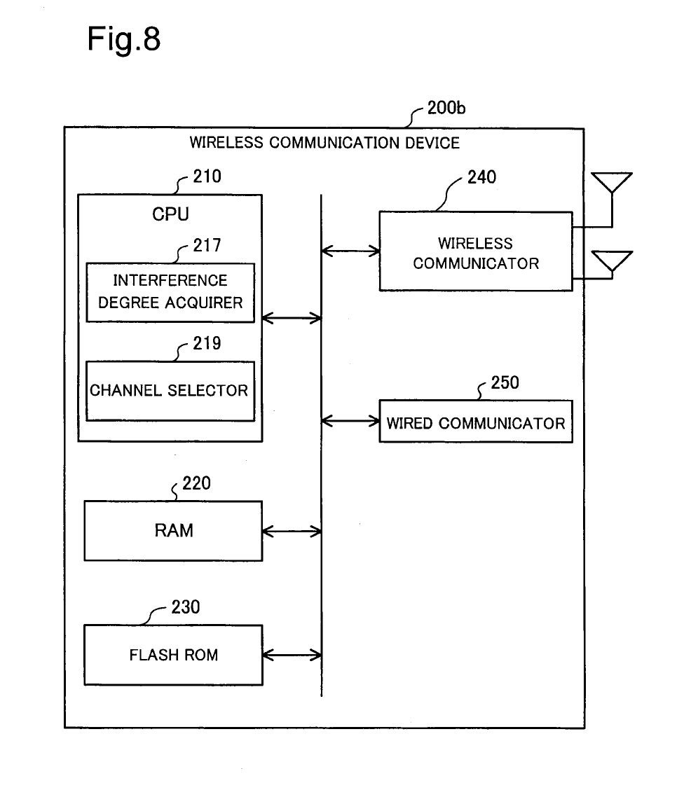

FIG. 8 is a block diagram illustrating a wireless communication device 200b according to a second embodiment. The wireless communication device 200b of the second embodiment includes: an interference degree acquirer 217 configured to obtain the current degree of interference at each available channel; and a channel selector 219 configured to select a channel used for wireless communication of interest among the available channels, based on the result obtained by the interference acquirer. The CPU 210 executes computer programs to implement these functional blocks. Otherwise the configuration of a RAM 220, a flash ROM 230, a wireless communicator 240 and a wired communicator 250 included in the wireless communication device 200b is the same as the configuration of the corresponding components included in the wireless communication device 200 according to the first embodiment.

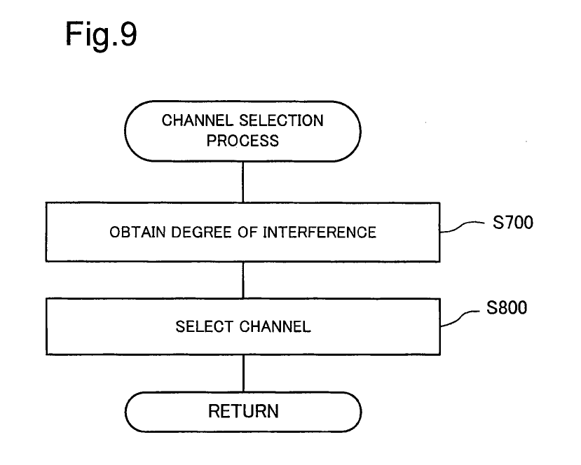

FIG. 9 is a flowchart showing a channel selection process executed by the wireless communication device 200b according to the second embodiment. This channel selection process for wireless communication obtains the degree of interference at each available channel at step S700, and selects a channel used for wireless communication, based on the obtained degrees of interference at step S800. This embodiment enables not a channel having a high degree of interference but a channel having a low degree of interference to be selected as the channel used for wireless communication.

### C. Other Embodiments

Other embodiments may include, for example, the following configurations.

Communication other than streaming may be taken into account for judgment of the necessity of channel switchover. For example, a similar series of processing to that of, for example, FIG. 6 of the above embodiment may be performed for download of a large-size file or communication associated with an online game. In other words, any of various factors specifiable as the criterion to determine whether wireless communication of interest is susceptible to interference of radio waves may be taken into account for judgment of the necessity of channel switchover. For example, the necessity of channel switchover may be judged, based on the criterion that a group of communications having the lower tolerance for packet loss has the higher demand for channel switchover than a group of communications having the higher tolerance for packet loss. Another embodiment may perform channel switchover without judging the necessity of channel switchover.

The above embodiment employs the RSSI and the result of radar wave detection as a parameter indicating the degree of interference. The disclosure may alternatively employ another parameter indicating the degree of interference. It is, however, preferable to employ a parameter indicating the degree of interference by radio wave from a source other than the wireless communication device of interest.

According to the above embodiment, the channel expected to have an interference based on the obtained history is excluded from candidate channels selected by the channel selector (S530 and S550 in FIG. 7). Another embodiment may select a channel used for wireless communication based on only the degree of interference at each channel without such processing.

The procedure of the above embodiment determines whether there is any available channel option having the frequency of radar wave detection that is equal to or less than the reference value and the history value of RSSI that is less than the history reference value during the streaming period among specified channels (steps S520 and S540) and, when there is any such available channel option, excludes the other channels from available channel options (steps S530 and S550). A modified procedure may individually perform the determination and restriction of available channel options based on radar wave detection and the determination and restriction of available channel options based on the history value of RSSI.

The procedure of the above embodiment performs the channel switchover when the degree of interference at the channel in use is equal to or greater than the reference value (S430: YES in FIG. 6), but does not perform the channel switchover under the predetermined condition (S440: NO) when the degree of interference at the channel is use is less than the reference value (S430: NO). A modified procedure may perform the channel switchover, independently of the degree of interference at the channel in use. This modification enables an optimum channel to be used consistently on the basis of the degree of interference.

The procedure of the above embodiment excludes any channel for which radar wave has been detected within a specified period (30 minutes) from available channels or available channel options (S510 in FIG. 7). A modified procedure may not exclude channels for which radar wave has been detected within a specified period from available option channels. The modified procedure may exclude any channel for which radar wave has been detected n times (where n is any integer of not less than 2) in a specified period from available channel options, for example, exclude any channel for which radar wave has been detected twice or more times in a specified period from available channels.

The above embodiment obtains the degree of interference at each channel by using FFT over the band of each available channel. Another embodiment may obtain the degree of interference at each channel by a technique other than FFT.

The radar wave-related step of the embodiment is specified by taking account of the laws and regulations in Japan at the time of filing this application. The radar wave-related step may be modified according to the laws and regulations at the date and location where the step is carried out.

The wireless communication device which the disclosure is applied to may be other than a wireless LAN access point. The disclosure may be applied, for example, a mobile router or a smart phone having the tethering function.

The organization scheme of history information, i.e., the criteria of grouping prior to information processing, is not limited to the day of the week and the time. For example, the history information may be organized by only the time, independently of the day of the week.

The time period subject to collection of history information may be longer or shorter than the latest 10 weeks.

The functions implemented by the software configuration according to the embodiment may be implemented by hardware configuration, and the functions implemented by the hardware configuration may be implemented by software configuration.

There are other available aspects as follows. According to one aspect, there is provided a wireless communication device comprising: circuitry configured to obtain a current degree of interference at each of a plurality of available channels; determine whether a wireless communication is susceptible to interference based on whether a condition corresponding to implementation of the wireless communication is satisfied; and set a channel for the wireless communication among the plurality of available channels based on the current degree of interference at each of the plurality of available channels when it is determined that the wireless communication is susceptible to interference. According to this aspect, in the case of communication determined to be susceptible to interference of radio wave (hereinafter referred to as “specific communication”), a channel used for the specific communication is selected, so that a channel is selectable according to the susceptibility to interference of radio wave. Additionally, the above feature is implemented in the wireless communication device, thus preventing significant complication of the network configuration and a significant increase in cost. The condition here may be, for example, a condition regarding the current degree of interference of a channel currently used for wireless communication or a condition regarding the past degree of interference of the channel currently used for wireless communication.

According to one embodiment of the wireless communication device of the above aspect, the circuitry is configured to maintain a first channel currently used for the wireless communication when the degree of interference at the first channel is less than a reference value, even when it is determined that the wireless communication is susceptible to interference. This embodiment can avoid an unnecessary process that selects a channel, despite that the channel used for wireless communication is tolerable to the wireless communication of interest.

According to another embodiment of the wireless communication device of the above aspect, the circuitry is configured to iteratively obtain the degree of interference of the plurality of the available channels including a channel adjacent to a channel used for the wireless communication and a channel not adjacent to the channel used for the wireless communication. This embodiment enables a channel to be selected according to the degree of interference, among the plurality of available channels including even the channels that are not adjacent to the channel used for wireless communication by the wireless communication device.

According to another embodiment of the wireless communication device of the above aspect, the condition corresponds to whether the wireless communication is for streaming, and the circuitry is configured to determine that the wireless communication is susceptible to interference when the wireless communication is for streaming. This embodiment specifies communication for streaming as the specific communication, so as to enable smoother reproduction by streaming. Streaming in the present application indicates a general technology that reproduces a file while downloading and means a wide-ranging concept including even techniques generally discriminated from streaming, such as progressive downloading.

Another embodiment of the wireless communication device of the above, the circuitry is configured to exclude a channel expected to have interference based on the channel's interference history as a candidate to be set as the channel for the wireless communication. This embodiment does not select a channel expected to have an interference, based on the obtained history with regard to the degree of interest, and can thus select a channel by taking into account prediction based on the past history, in addition to the current degree of interference. The above process may be performed by an application that actively detects channels that are expected to have interference and exclude the detected channels. The above process may alternatively be performed by an application that detects channels that are not expected to have interference and exclude channels other than the detected channels. The disclosure may be configured to consistently perform the above process or may be configured to perform the above process only under a specified condition.

Another embodiment of the wireless communication device of the above aspect, the circuitry is configured to prevent changing from a first channel currently used for the wireless communication when the degree of interference at the first channel is less than a reference value, but to allow the first channel to be changed when it is determined that the wireless communication is susceptible to interference. This embodiment does not perform channel switchover when the degree of interference at the channel in use is less than the reference value, thus preventing unnecessary channel switchover.

According to another embodiment of the wireless communication device of the above aspect, the circuitry is configured to exclude a channel for which radar wave has been detected in a specified period from as a candidate channel set for the wireless communication. This embodiment excludes the channel for which radar wave has been detected in the specified period, from the available channels, thus avoiding the use of the channel for which radar wave has been detected in the specified period.

According to another embodiment of the wireless communication device of the above aspect, the circuitry is configured to obtain the degree of interference at each of the plurality of available channels by utilizing FFT for a band of each of the plurality of available channels. This embodiment obtains the degree of interference at each channel by utilizing FFT, thus enabling the degrees of interference at the respective channels to be obtained in parallel.

According to another embodiment of the wireless communication device of the above aspect, the circuitry is configured to: identify whether the degree of interference of any of a first plurality of channels available in a first frequency band is less than a reference value; and set the channel for the wireless communication from among the first plurality of channels available in the first frequency band having the degree of interference less than the reference value.

According to another embodiment of the wireless communication device of the above aspect, the circuitry is configured to: identify whether the degree of interference of any of a second plurality of channels available in a second frequency band is less than a reference value when the degree of interference of the first plurality of channels available in the first frequency band is greater than the reference value; and set the channel for the wireless communication from among the second plurality of channels available in the second frequency band having the degree of interference less than the reference value.

According to another aspect, there is provided a method of selecting a channel for wireless communication. the method comprising: obtaining, by circuitry of the wireless communication device, a current degree of interference at each of a plurality of available channels; determining, by the circuitry, whether a wireless communication is susceptible to interference based on whether a condition corresponding to implementation of the wireless communication is satisfied; and setting, by the circuitry, a channel for the wireless communication among the plurality of available channels based on the current degree of interference at each of the plurality of available channels when it is determined that the wireless communication is susceptible to interference.

The plurality of structural components included in each aspect of the disclosure described above are not all essential, but some structural components among the plurality of structural components may be appropriately changed, omitted or replaced with other structural components or part of the limitations may be deleted, in order to solve part or all of the problems described above or in order to achieve part or all of the advantageous effects described herein. In order to solve part or all of the problems described above or in order to achieve part or all of the advantageous effects described herein, part or all of the technical features included in one aspect of the disclosure described above may be combined with part or all of the technical features included in another aspect of the disclosure described above to provide still another independent aspect of the disclosure.

For example, one aspect of the disclosure may be implemented as a device including part or all of the action: to obtain, to determine and to set. In other words, this device may obtain or may not obtain. This device may have determine or may not determine. This device may have set may not set. To obtain may be, for example, to obtain a current degree of interference at each of a plurality of available channels. To determine may be, for example, to determine whether a wireless communication is susceptible to interference based on whether a condition corresponding to implementation of the wireless communication is satisfied. To set may be, for example, to set a channel for the wireless communication among the plurality of available channels based on the current degree of interference at each of the plurality of available channels when it is determined that the wireless communication is susceptible to interference. This device may be implemented, for example, as a wireless communication device but may also be implemented as a different device other than the wireless communication device. This aspect can solve at least one of various problems, for example, downsizing of a device, cost reduction, resource saving, easiness of manufacture and improved usability. Part of all of the technical features involved in the respective embodiments of the wireless communication device described above may also be applicable to this device.

The disclosure may be implemented by any of various aspects other than those described above: for example, a method of selecting a channel used for wireless communication, a program for implementing this method and a non-transitory storage medium in which this program is stored.

The disclosure is not limited to the above embodiments, examples or modifications, but a diversity of variations and modifications may be made to the embodiments without departing from the scope of the disclosure. For example, the technical features of the embodiments, examples or modifications corresponding to the technical features of the respective aspects described in SUMMARY OF DISCLOSURE may be replaced or combined appropriately, in order to solve part or all of the problems described above or in order to achieve part or all of the advantageous effects described above. Any of the technical features may be omitted appropriately unless the technical feature is described as essential herein.

What is claimed is:

1. A wireless communication device, comprising:
circuitry configured to
obtain a current degree of interference at each of a plurality of available channels;
determine whether a wireless communication is susceptible to interference based on whether a condition corresponding to implementation of the wireless communication is satisfied; and
set a channel for the wireless communication among the plurality of available channels based on the current degree of interference at each of the plurality of available channels when it is determined that the wireless communication is susceptible to interference.

2. The wireless communication device according to claim 1, wherein
the circuitry is configured to maintain a first channel currently used for the wireless communication when the degree of interference at the first channel is less than a reference value, even when it is determined that the wireless communication is susceptible to interference.

3. The wireless communication device according to claim 1, wherein
the circuitry is configured to iteratively obtain the degree of interference of the plurality of the available channels including a channel adjacent to a channel used for the wireless communication and a channel not adjacent to the channel used for the wireless communication.

4. The wireless communication device according to claim 1, wherein
the condition corresponds to whether the wireless communication is for streaming, and
the circuitry is configured to determine that the wireless communication is susceptible to interference when the wireless communication is for streaming.

5. The wireless communication device according to claim 1, wherein
the circuitry is configured to exclude a channel expected to have interference based on the channel's interference history as a candidate to be set as the channel for the wireless communication.

6. The wireless communication device according to claim 1, wherein
the circuitry is configured to prevent changing from a first channel currently used for the wireless communication when the degree of interference at the first channel is less than a reference value, but to allow the first channel to be changed when it is determined that the wireless communication is susceptible to interference.

7. The wireless communication device according to claim 1, wherein
the circuitry is configured to exclude a channel for which radar wave has been detected in a specified period from as a candidate channel set for the wireless communication.

8. The wireless communication device according to claim 1, wherein
the circuitry is configured to obtain the degree of interference at each of the plurality of available channels by utilizing FFT for a band of each of the plurality of available channels.

9. The wireless communication device according to claim 1, wherein the circuitry is configured to:
identify whether the degree of interference of any of a first plurality of channels available in a first frequency band is less than a reference value; and
set the channel for the wireless communication from among the first plurality of channels available in the first frequency band having the degree of interference less than the reference value.

10. The wireless communication device according to claim 9, wherein the circuitry is configured to:
identify whether the degree of interference of any of a second plurality of channels available in a second frequency band is less than a reference value when the degree of interference of the first plurality of channels available in the first frequency band is greater than the reference value; and
set the channel for the wireless communication from among the second plurality of channels available in the second frequency band having the degree of interference less than the reference value.

11. A method performed by a wireless communication device, the method comprising:
obtaining, by circuitry of the wireless communication device, a current degree of interference at each of a plurality of available channels;
determining, by the circuitry, whether a wireless communication is susceptible to interference based on whether a condition corresponding to implementation of the wireless communication is satisfied; and
setting, by the circuitry, a channel for the wireless communication among the plurality of available channels based on the current degree of interference at each of the plurality of available channels when it is determined that the wireless communication is susceptible to interference.

12. A non-transitory computer-readable medium including computer program instructions, which, when executed by a wireless communication device, cause the wireless communication device to:
obtain a current degree of interference at each of a plurality of available channels;
determine whether a wireless communication is susceptible to interference based on whether a condition corresponding to implementation of the wireless communication is satisfied; and
set a channel for the wireless communication among the plurality of available channels based on the current degree of interference at each of the plurality of available channels when it is determined that the wireless communication is susceptible to interference.
